(19) United States
(12) Patent Application Publication
(10) Pub. No.: US 2003/0084452 A1
(43) Pub. Date: May 1, 2003

(54) Entertainment portal

(76) Inventors: Timothy L. Ryan, McKinney, TX (US); Adam J. Kunzman, Fairview, TX (US)

Correspondence Address: TEXAS INSTRUMENTS INCORPORATED, P O BOX 655474, M/S 3999, DALLAS, TX, 75265

(21) Appl. No.: 10/262,472

(22) Filed: Sep. 30, 2002

Related U.S. Application Data
(60) Provisional application No. 60/328,476, filed on Oct. 11, 2001.

(51) Int. Cl. G06F 3/00

(52) U.S. Cl. 725/51

(57) ABSTRACT

An entertainment portal, which serves as a common user interface (UI) to access local and remote entertainment content, integrate and categorize it, then display it on a single HDTV. The interface aggregates content from many different delivery mechanisms and presents it in a single form. The portal, to be datacast by a local broadcaster, will integrate content creators, broadcasters, advertisers, manufactures, websites, and home consumers by channeling people and content through a uniform technology experience. The user interface, which is hosted remotely and cached locally, allows for continuous updating of the portal so that up-to-the-minute content is displayed on the screen, while ensuring that the portal is always available, even when the remote host is not. This allows the UI to grow, change, and update daily without affecting the display hardware. The entertainment portal offers available content organized around central themes, with the capability for individual family members to establish sub-themes that can be quickly accessed.

### CROSS-REFERENCE TO RELATED INVENTION

This invention is related to the invention disclosed and claimed in co-pending U.S. patent application, filed of even date with the filing date of this Application and bearing Attorney's Docket No. TI-33228, the contents of which are hereby incorporated by reference.

### FIELD OF THE INVENTION

The present invention relates to the presentation of entertainment content and particularly to the aggregation of content from broadcast, Internet, and local media.

### BACKGROUND OF THE INVENTION

So much information is now available, with a large portion of this information being delivered by means of television and the Internet, that it is becoming very cumbersome to handle it all. Entertainment and other broadcast information are usually displayed on small display screens and Internet content on personal computer (PC) screens. With so much data, however, multiple screens are often required to make this content available to the modern user.

The user interface (UI) typically resides in the display or in a set-top-box (STB). Although some STBs support interactive television solutions for software downloads, the resulting applications reside inside the STB and therefore remain static until a subsequent download is requested. Also, content comes from many different sources, requiring the user to subscribe to various services, such as cable or satellite TV and an Internet Service Provider (ISP). Internet content requires browsers and hyperlink text capability to handle the data.

What is needed is a way to aggregate all this content into a single HDTV display system, providing family entertainment that presents content and navigation in an easy-to-use manner. Now that high definition television (HDTV) is available, having at least 1280×720 pixel resolution, this is possible. The entertainment portal of the present invention meets these needs by providing a common interface to access local and remote entertainment content and then integrate and categorize this content to make searching for entertainment easier and faster. The entertainment portal aggregates content from different delivery mechanisms and presents it in a single easy to use form.

### SUMMARY OF THE INVENTION

As entertainment choices increase to include broadcast, Internet, and local media, it becomes desirable to locate and categorize them into easily accessible and understood thematic groups. The present invention discloses an entertainment portal, which serves as a common interface to access local and remote entertainment content, integrate and categorize it, and then display it on a single HDTV display screen. The interface aggregates content from many different delivery mechanisms, whether it be terrestrial broadcast, cable. satellite, Internet. DVD. VCR or others, and presents it in a single form without the need for reformatting for viewing on lower resolution displays. Ideally, the portal will normally be datacast by a local broadcaster, but can also be hosted on the Internet. For the most part information can be pulled from existing databases and supplied to the entertainment portal. The objective of the entertainment portal is to integrate content creators, broadcasters, advertisers, manufactures, websites, and home consumers by channeling people and content through a uniform technology experience.

With the entertainment portal, a user interface (UI) is hosted remotely, and cached locally, rather than in the conventional set-top-box. This allows the UI to be continuously updated so that up-to-the-minute content is displayed on the screen, while ensuring that the portal is always available, even when the remote host is not. Additionally, the UI controls the screen allowing a particular look-and-feel to its appearance. From this UI the user of the system can change channels, select viewing modes, adjust display parameters, etc. The fact that the UI is remote, provides the capability for it to grow, change, and update daily without affecting the display hardware.

The dynamic UI of the present invention allows the available content to be organized around themes. This provides family entertainment with quick access to associated sub-themes setup for each family member. For example, content such as on-line shopping, on-line multi-player games, local community information, stock quotes, weather forecast, sports scores, and the exchange of ideas concerning the community are all aggregated and presented on a singe display screen. The home user will not be particularly concerned about where the content originates or where it resides, but that it is easily accessible and presentable on a single HDTV display screen, providing a one-stop entertainment experience. Using a remote control, which mimics the HDTV screen, people using the system will have access to programs, movies, websites, games, and shopping opportunities all presented in one seamless format.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an example of a display template for the Home Page screen of the entertainment portal of the present invention, showing the main menu along with featured and local content.

FIG. 2 is an example of a display template for a typical Help page of the entertainment portal of the present invention.

FIG. 3 illustrates the TV Program Guide, which gets updated periodically by the remote User Interface, along with text and picture-in-window describing the selected program.

FIG. 4 is an example of the page for the Sports theme.

FIG. 5 is an example of the page for the News & Information theme.

FIG. 6 is an example of the page for the Entertainment theme.

FIG. 7 is an example of the page for the Games theme.

FIG. 8 is an example of the page for the Shopping theme.

FIG. 9 is an example of the page for the Community theme.

FIG. 10 is an example of a display template for a typical Setup page of the entertainment portal of the present invention.

### DETAILED DESCRIPTION OF THE PREFERRED EMBODIMENTS

The present invention discloses an entertainment portal, for a project known as StarCast, ideally datacast by local broadcasters, which serves as a common interface to access local and remote entertainment content, integrate and categorize it, and then display it on a single HDTV display screen. The interface aggregates content from many different delivery mechanisms, whether it be terrestrial broadcast, cable, satellite, Internet, DVD, or VCR, and presents it in a single form without the need for reformatting for viewing on lower resolution displays. The objective of the entertainment portal is to integrate content creators, broadcasters, advertisers, manufactures, websites, and home consumers by channeling people and content through a uniform technology experience.

The entertainment portal establishes a user interface (UI), hosted remotely, and cached locally, rather than in the conventional set-top-box. This allows the UI to be continuously updated so that up-to-the-minute content is displayed on the screen, while ensuring that the portal is always available, even when the remote host is not. The UI can grow, change, and update daily without affecting the display hardware.

The dynamic UI of the present invention allows the available content to be organized around themes, with individual family members or users being able to set up quickly accessible sub-themes where he or she can access programs, movies, websites, games, and shopping opportunities all in one seamless experience.

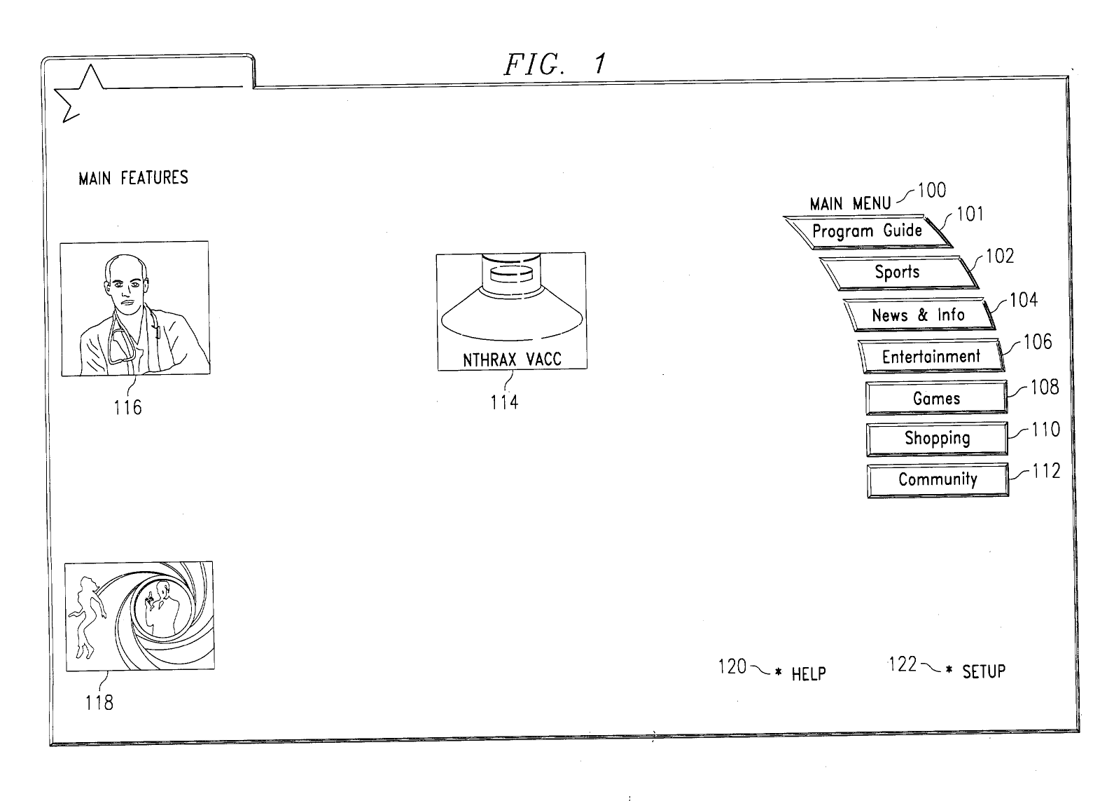

FIG. 1 is an example of a display template showing the Home Page screen for the entertainment portal of the present invention. This shows the Main Menu 100, which in this example includes the Program Guide 101, Sports 102, News and Information 104, Entertainment 106, Games 108, Shopping 110, and Community 112. Also shown are Featured Content windows 114, 116, 118 along with links to Help 120 and Setup 122 pages. These content windows are important to the people providing the portal since they not only supply information for the end-user, but also provide a potential revenue stream for the portal administrator through advertising.

Using the portal, the user will have the ability to access entertainment and other information in a seamless interface, which provides a blurred distinction between TV and web content. The user will not be particularly concerned about where the content originates or where it resides, but that it is easily accessible and presentable on a single HDTV display screen, providing a one-stop experience.

Initially, the themes listed in the Main Menu are established, although the portal administrator can add any new theme. This will allow users to find related information quickly and see it displayed on a single high-definition screen, as well as perform interactive functions from the home.

The themes are established around identified target audience needs and wants, therefore a need for these to grow and change exists. The themes are the building blocks for the personalization features of the portal. These themes will consist of television channels, websites, TV/web site combinations, commerce opportunities, and community features all rolled-up in a one-stop experience. Content providers and advertiser will have the ability to add and expand content within defined areas, thereby providing a source of revenue into the industry.

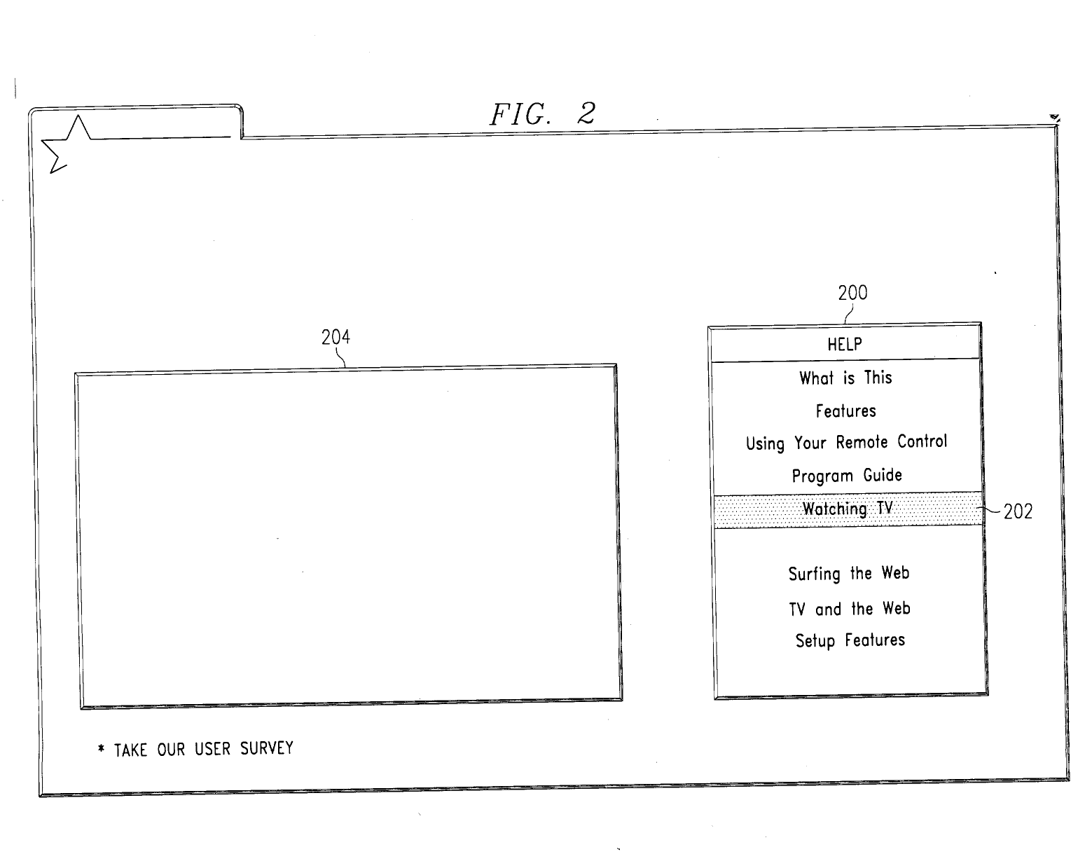

FIG. 2 is an example showing a template for a Help page embedded in the entertainment portal of the present invention. This shows the Help Menu 200 with various subjects listed. These subjects can be added to and changed on a regular basis by the portal provider administrator. In this example, the Watching TV line 202 is highlighted to open up a text window 204 describing the TV mode of operation. As a side, it is an interesting feature of the entertainment portal, that the system can be used in the TV only mode, the Web only mode, or the Web can be displayed from the TV only menu where both are displayed in a split-screen format on the DHTV display screen.

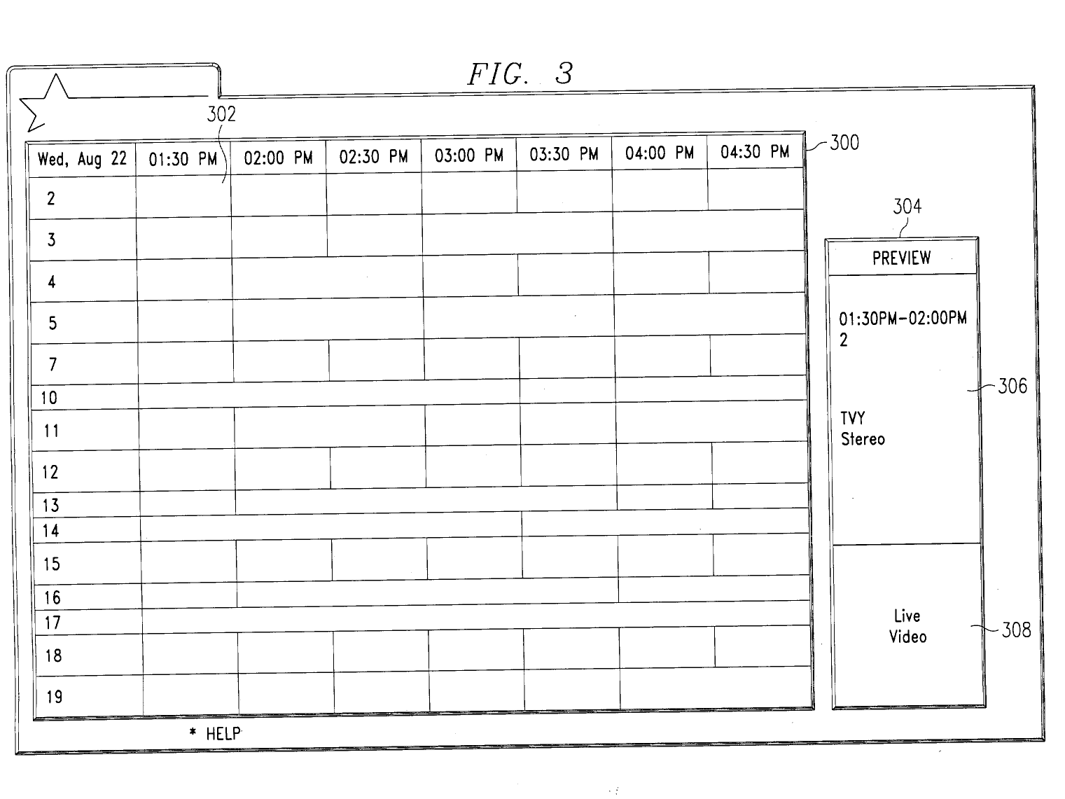

FIG. 3 illustrates the TV Program Guide 300, which gets updated periodically by the remote User Interface, along with a Preview window 304. The Preview window contains both text 306 and live video picture-in-window 308, which describe the selected program. This program guide 300, which gets updated periodically by the remote User Interface, provides quick access to the available TV content.

In operation, when a program is selected, such as Reading Rainbow 302, a Preview window 304 opens, gives the highlights for the selected program. In this case the program is on Channel 2 from 1:30 to 2:00 PM, genre is “children,” rated TVY (youth), presented in stereo, and is about “Tony helping his father make pizza.” Live video of the program is also shown as a picture-in-window 308. The user can select the program through the remote control to go to a full-screen view or can continue with the program guide.

All available content in this system is organized into an easy-to-navigate application, which falls into three categories: (1) traditional broadcast and cable channels, (2) programs broadcast in HDTV with companion websites, and (3) interactive content found on the Web. In general, TV content, web content, and combinations of the two are lumped together into simply entertainment, essentially blurring the distinctions between TV and the Web.

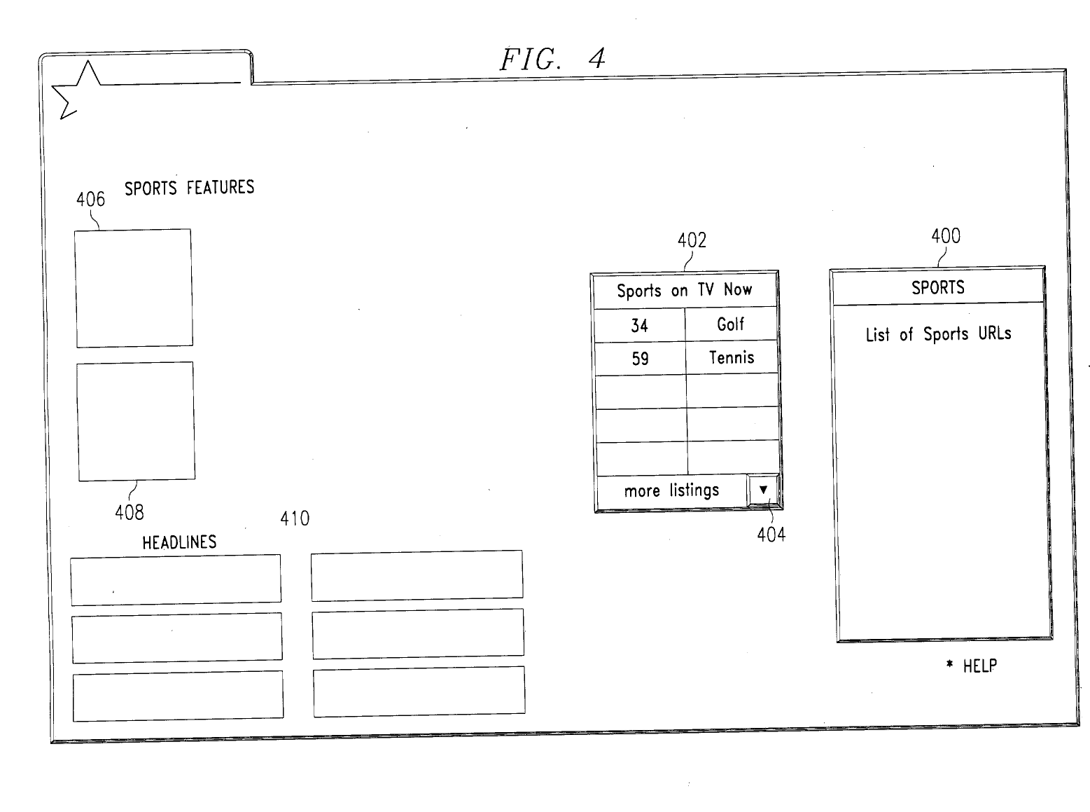

FIG. 4 is an example of the page for the Sports theme. This theme combines TV programming and website content to provide the sports enthusiast immediate access to all related content. The Sports Menu window 400 lists the content primarily available on the Web. A second window 402 shows the sports programs on TV at the present time; e.g., golf and tennis. If more channels are available than will fit onscreen at one time, the “more listings” tab 404 can be used to scroll through additional channels currently broadcasting sporting events. There are sports feature stories 406, 408 that can be addressed through the remote control, as well as sports headlines 410 giving the latest information in areas like football, baseball, basketball, and auto racing. This page gets updated from time to time, as new content becomes available, by means of the datacast.

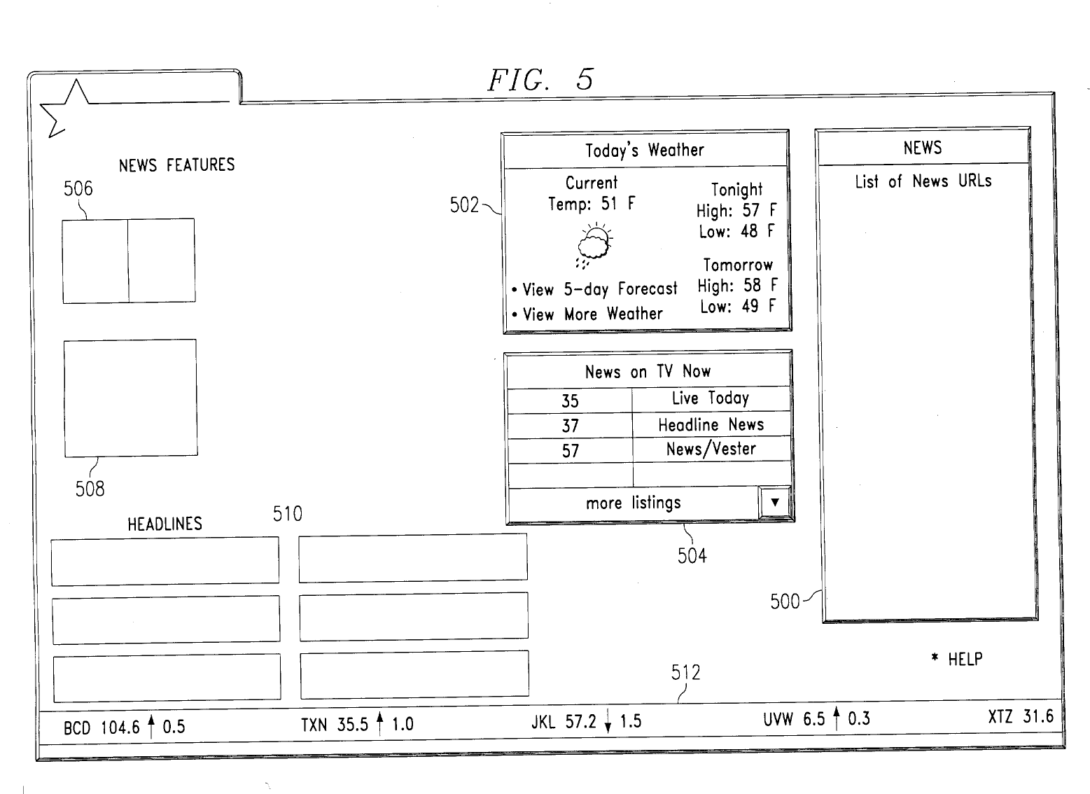

FIG. 5 is an example of the page for the News & Information theme. This theme is basically an expansion of the home office, providing all the accessible TV and Web content for local, national, and world news and information to the information-hungry user. The News Menu window 500 lists the major websites available, while a second window 502 gives the current weather for the local area, as well as links to weather forecasts and other weather related information. A third window 504 lists the News on TV at the present time. There are also major news stories 506, 508, as well as news headlines 510, which can be addressed for viewing of the full text or video. Also shown is a streaming video banner 512 overlaying real-time stock quotes across the screen.

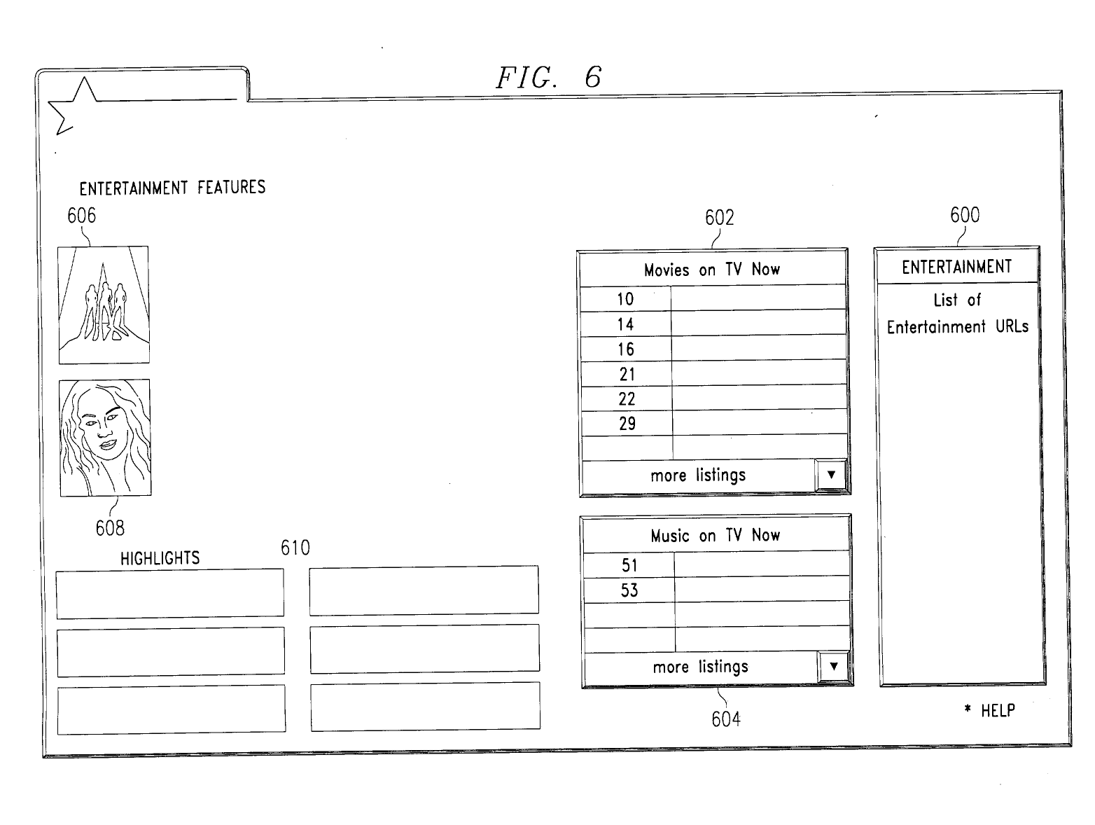

FIG. 6 is an example of the page for the Entertainment theme. Overall entertainment is what the whole portal is about, but this entertainment theme lists the various entertainment websites 600, as well as the movies 602 now showing on TV, and the music 604 now playing on TV. As for the previous themes, there are feature stories 606, 608 relating to the entertainment industry, which can be opened to see the full text, as well as various highlights 610 for both TV and the Web. The general format for all the theme home pages are the same so that the user becomes very familiar with navigating around the pages.

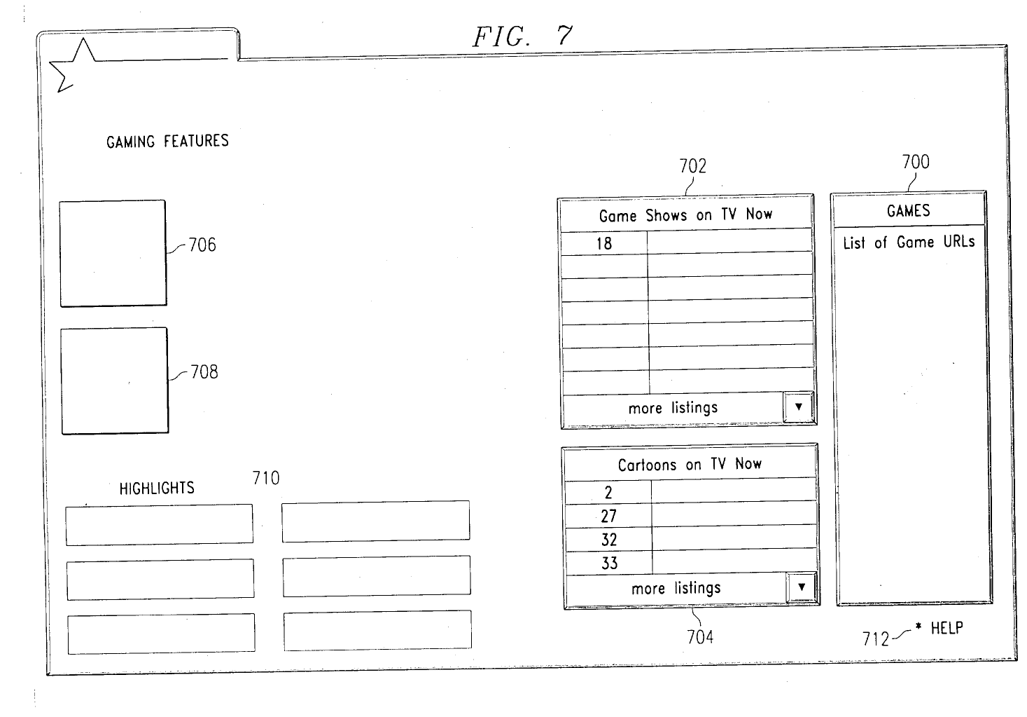

FIG. 7 is an example of the page for the Games theme. This theme is all about children. In general, the theme is expanded to include cartoons and comics. Sub-themes can be added for each age group. Parents will feel secure in sitting a child down in front of this theme and allowing him or her to select the entertainment of their choice. Supporting content explaining the parental control features is included. A first window 700 list the game related information on the WEB. A second window 702 and a third window 704 list the game shows and cartoons, respectively, which are currently on TV. The Gaming Features section may include information on a new or popular game 706 or interesting information about a particular game show 708. The Highlights 710 section provides a quick path to checkout various aspects of the theme. As is the case for each page, Help 712 is always available so that by selecting it, information about how to use the current page or the overall portal is available.

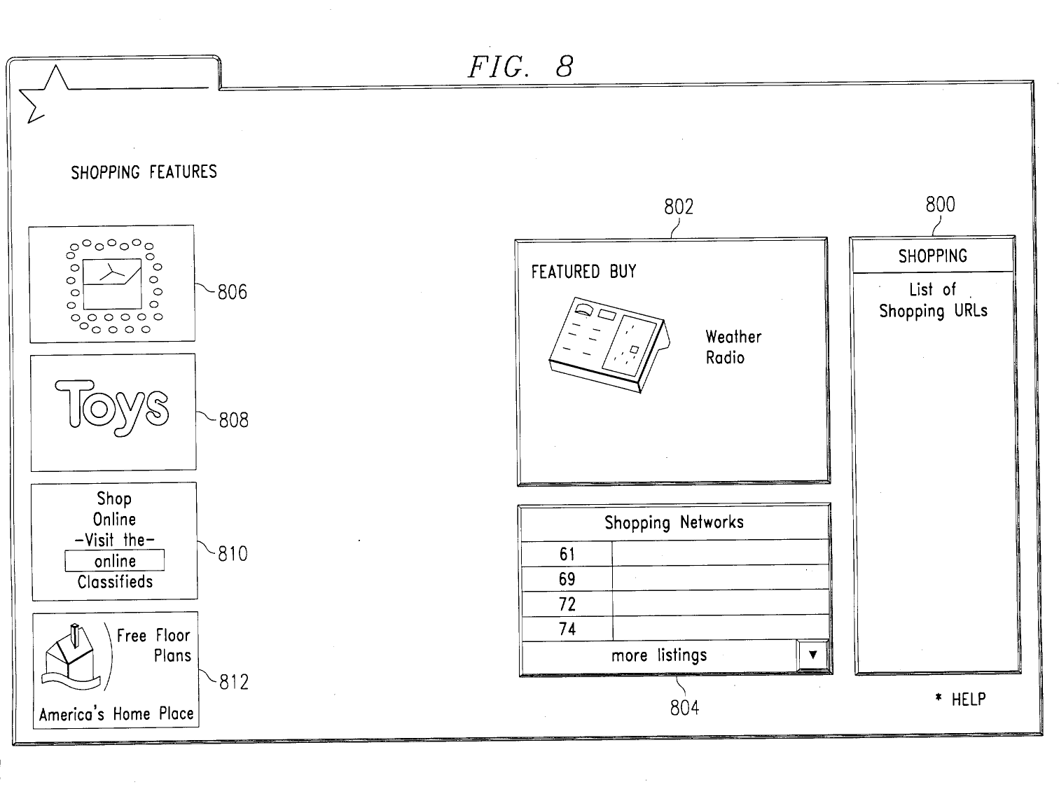

FIG. 8 is an example of the page for the Shopping theme. This theme is a centralized marketplace for the user to access a variety of on-line shopping sites. A Shopping window 800 lists various websites relating to on-line shopping. There is a Featured Buy window 802 showing a featured product and another window 804 listing the TV shopping networks. There are other advertising windows; e.g., (shown) for The WRAL Store 806, eToys 808, Yellow Pages 810, and America's Home Place 812, any of which can be quickly addressed.

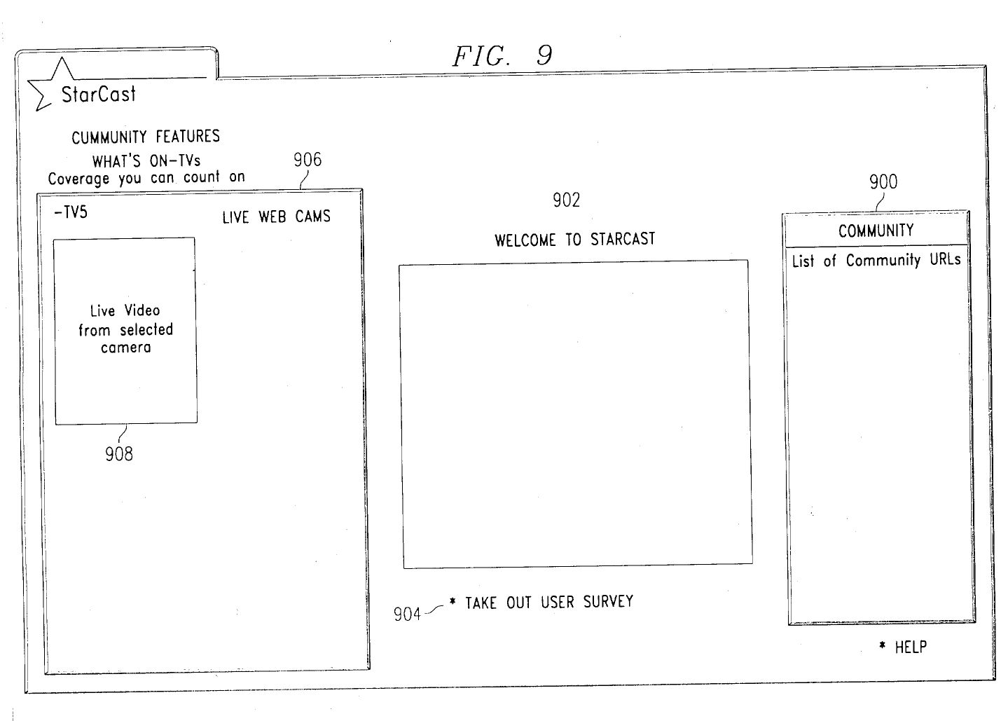

FIG. 9 is an example of the page for the Community theme. This concept not only offers the users a portal to the world, but also to their own backyards. This community theme highlights local content and special offerings, such as special discounts to HDTV shoppers by local retailers. It also provides a vehicle for users to give feedback relating to community issues and events. Polls can be quickly taken to obtain the people's views relative to various pressing matters, which may be impacting the community. The Community window 900 lists the various local websites of interest to the local residents. A “Welcome to StarCast” message 902 provides other important local information and can poll the audience; e.g., as shown with the “Take our User Survey” 904. A Community Features TV window 906 lists various Web Cams available for instant viewing of what's happening around the community. By selecting one of the cameras, live video or a still image is seen in a picture-in-window 908, which may show the traffic conditions at a busy intersection or the activity at the local arena, etc.

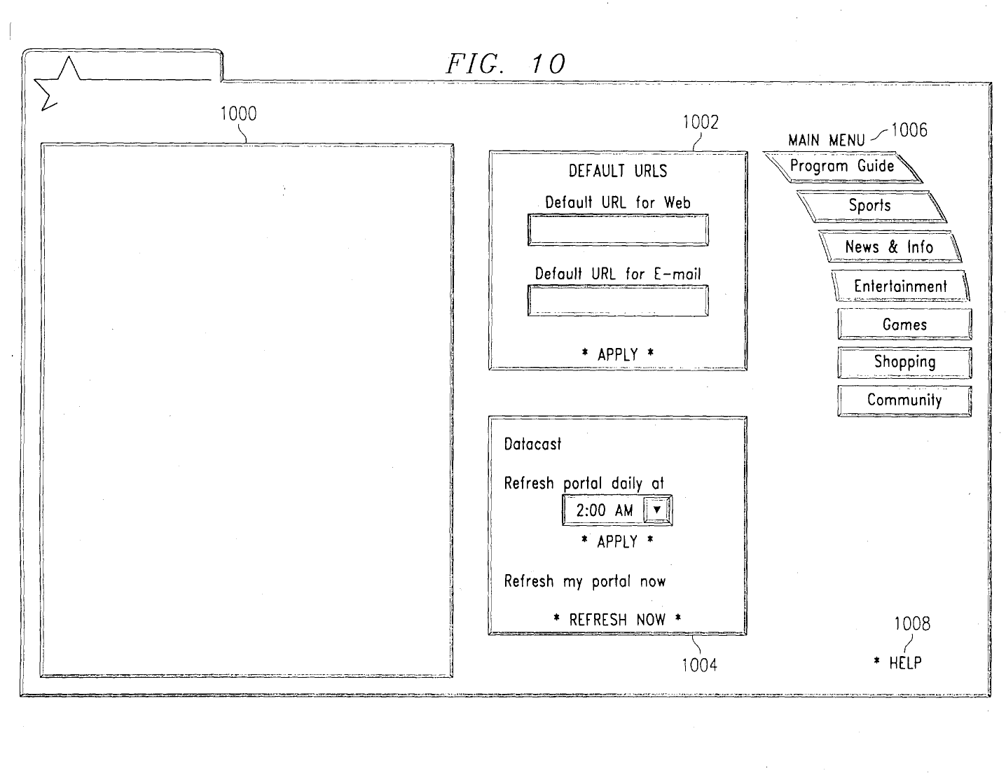

FIG. 10 is an example of a display template for a typical Setup page of the entertainment portal of the present invention. This includes Portal Setup instructions 1000, as well as default URL addresses 1002 for both the web and e-mail, and a place to indicate the user's portal refresh 1004 requirements. Again the Main Menu 1006 is shown and the Help 1008 function is provided. The portal administrator can add other main themes and functions to the portal as needed.

As discussed earlier, the remote control is extremely integral to the entire system. It functions as both a navigation and selection device. It controls the traditional television and DVD functions, as well as serving as the portal's primary navigation tool, with the need for switching back-and-forth between the keyboard, mouse, and remote control being de-emphasized. The interface on the remote control mimics the on-screen display as much as possible. For example, when the user sees four menu options on the screen, the remote display will show the same four options, matching text and visual design as much as the monochrome remote display will allow. This parallel user interface will minimize any user confusion. One limitation of the remote control, however, is that its interactive communication ability is only one-way—from the user to the portal. A dual interface will be used to address this limitation by providing an on-screen interface that is predictable enough to be fully mimic on the remote. The remote control has a minimal number of buttons. For example seven could be used as follows: Volume ↓↑, Channel ↓↑, Multi-purpose →∴, and Mute, with the remaining data being displayed on a LCD touch screen.

The Entertainment Portal of the present invention provides:

(1) thematic content,

(2) family entertainment with associated sub-themes,

(3) on-line shopping,

(4) multi-player games,

(5) community information, and

(6) streaming information sources, such as stock quotes and weather all on one HDTV display screen.

While this invention has been described in the context of a preferred embodiment, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

What is claimed is:

1. A method for accessing entertainment content regardless of its delivery mechanism, the method comprising:
providing entertainment content to an HDTV display by means of a dynamic graphical user interface, said interface hosted remotely and delivered continuously to said HDTV display and operable to access available content from multiple sources;
aggregating said content into entertainment themes; and
displaying said content in a seamless format without distinction between content types.

2. The method of claim 1, comprising:
updating said user interface without affecting the display hardware.

3. The method of claim 1, said aggregating comprising:
aggregating said content comprising both TV and Web information.

4. The method of claim 1, said aggregating comprising:
aggregating said content delivered by at least one source from the group consisting of: terrestrial broadcast, satellite, cable, Internet, DVD, VCR, streaming video, streaming audio, and local media.

5. The method of claim 1, comprising:
personalizing said themes.

6. The method of claim 1, said aggregating comprising:
aggregating said content into entertainment themes including at least one said theme selected from the group consisting of: sports, news and information, entertainment, games and cartoons, shopping, and community.

7. The method of claim 1, said aggregating comprising:
aggregating said content in entertainment themes including at least one theme selected from the group consisting of: TV channels, web sites, TV/web site combinations, commerce opportunities, and community features.

8. The method of claim 1, said aggregating comprising:
categorizing said content by users into sub-themes.

9. The method of claim 1, said aggregating comprising:
aggregating said content into said entertainment themes having elements that move between components of the group consisting of hardware components, software components, content types, and content formats.

10. The method of claim 1, comprising:
providing a remote control having a display that mimics the HDTV screen.

11. The method of claim 1, comprising datacasting at least a portion of said content by local broadcasters.

12. The method of claim 1, comprising hosting at least a portion of said content on the Internet.

13. The method of claim 1, said displaying comprising:
displaying all content on a single HDTV display screen.

14. An entertainment portal for accessing content regardless of its delivery mechanism, said portal comprising:
a dynamic graphical user interface, said interface being hosted remotely from said HDTV display, said interface operable to access available content from multiple sources, said content being integrated and categorized into entertainment themes, said dynamic graphical user interface providing said content in a seamless format without distinction between content types; and
an HDTV display having a resolution of at least 1280×720 pixels receiving said content from said dynamic graphical user interface.

15. The portal of claim 14, said dynamic graphical user interface integrating hardware selected from the group consisting of: said HDTV display, a DVD player, a personal computer, a keyboard, a mouse, a remote control, a surround sound audio system, and a VCR.

16. The portal of claim 14, comprising a remote control mimicking the HDTV screen.

17. The portal of claim 14, wherein said user interface controls said display.

18. The portal of claim 14, said dynamic graphical user interface providing content comprising both TV and Web information.

19. The portal of claim 14, said dynamic graphical user interface providing content delivered by at least one source selected from the of the group consisting of:
terrestrial broadcast, satellite, cable, Internet, DVD, VCR, streaming video, streaming audio, and local media.

20. The portal of claim 14, wherein all content is displayed on a single said HDTV display screen.
